(19) United States
(12) Patent Application Publication
(10) Pub. No.: US 2002/0152899 A1
(43) Pub. Date: Oct. 24, 2002

(54) Apparatus and system for vending pasta and sauce

(76) Inventors: Steve Young, Kirkwood, MO (US); Paul Bennett, St. Louis, MO (US)

Correspondence Address: Steven Young, 462 Dickins Avenue, St. Louis, MO, 63122, US

(21) Appl. No.: 09/839,450

(22) Filed: Apr. 19, 2001

(51) Int. Cl. A23L 1/00; A23C 3/00

(52) U.S. Cl. 99/357; 426/523

(57) ABSTRACT

A pasta and sauce vendor including a hopper storing at least one portion of pasta, a pasta cooker for cooking a portion of pasta received from the hopper, a pasta dispenser for dispensing the portion of cooked pasta received from the pasta cooker, a disposable sauce container having a dispensing tube, a holder for the disposable sauce container that disposes the dispensing tube of the container to dispense sauce directly onto the cooked pasta such that the sauce contacts only the container dispensing tube and the cooked pasta and a vending circuit whereby a payment is received, and, in response to the receipt of the payment, the pasta is cooked and dispensed and thereafter the sauce is dispensed.

### CROSS-REFERENCE TO RELATED APPLICATIONS

None.

### STATEMENT REGARDING FEDERALLY SPONSORED RESEARCH OR DEVELOPMENT

Not applicable.

### BACKGROUND OF THE INVENTION

1. Field of the Invention

This invention relates generally to automatic, self-service vending of both pasta and sauce, together with maintenance and supply systems for such vending machines.

2. Related Art

Speed and efficiency of maintenance, service and restocking are critical to the self-service food vending industry. Profitability is directly proportionate to the volume of vending machines serviced by stockmen and servicemen and the efficiency of their route and schedule. Efficient and rapid maintenance and stocking systems are needed for self-service machines to profitably vend types of food that are new to self service vending, like pasta combined with sauce.

Speed and efficiency are increased by decreasing the time necessary for cleaning equipment and restocking food hoppers and dispensers. Dispensing containers for vending individual portions of food which are not individually packaged are needed in the art. It is particularly advantageous to vend individual portions of food from an undifferentiated mass if the vending can be done without any food touching equipment that is permanently installed. This would obviate cleaning. Such a system is needed for dispensing viscous, paticulate-containing foods like pasta sauce.

Rapid pasta cooking for restaurants is known. Reference is made to U.S. Pat. Nos. 5,033,364; 5,010,806; 5,172,627; 5,215,001; all to Narcisi; 5,241,899 and 5,462,210 to Kuhlman and 4,803,916 to Tacconi. Pasta vending, however, has not had automated sauce vending available for combination with it. Therefore, there is a particular need for self-service vending of pasta and sauce to develop efficient, economical and rapid systems and apparatuses for maintenance, service and stocking.

### SUMMARY OF THE INVENTION

The present invention is an apparatus and system for automatic self-service vending of pasta with sauce in a manner that is fast, efficient and economical to maintain, service and stock.

In a single, preferably countertop, unit, a high speed pasta cooker is activated in response to receipt of a patron's payment by conventional vending methods. Single servings of pasta are dispensed by a modular, preferably plastic, drum, or other type of hopper, to a pasta cooker. A serviceman may rapidly swap an empty pasta-dispensing module for a full one.

The pasta cooker dispenses cooked pasta onto a plate. The patron may then push a button to select a sauce to be immediately dispensed over the pasta. The pasta sauce is also dispensed from a replaceable modular unit. In the preferred embodiment, the vending machine is stocked with the sauce in a sealed, flexible bag. In operation, the sauce is dispensed through a tube held in position by a guide sheath. The dispensing tube is incorporated with the sauce pouch, and likewise disposable. The dispensing tube in its operative placement is longer than the guide sheath. Food is dispensed from the bag through the tube and directly on to the plate of pasta. Accordingly, the food never comes in contact with the guide sheath, or any other permanent fixture of the vending machine. Accordingly, no time must be taken by a serviceman for cleaning parts. The old sauce bag is simply removed and disposed of. A new sauce bag is dropped in place, the empty pasta hopper is swapped out for a full hopper, and the serviceman may quickly continue his route.

Further features and advantages of the present invention, as well as the structure and operation of various embodiments of the present invention, are described in detail below with reference to the accompanying drawings.

### BRIEF DESCRIPTION OF THE DRAWINGS

FIG. 1 is a perspective view of a preferred embodiment of the exterior of the pasta and sauce vendor.

FIG. 2 is a front view of the exterior of the pasta and sauce vendor apparatus.

FIG. 3 is a front view of the interior of the pasta and sauce apparatus depicting the pasta cooking and dispensing apparatus.

FIG. 4 is a side view of the interior of the pasta and sauce vendor showing the sauce dispensing apparatus.

FIG. 5 is a front view of the disposable sauce container before attachment of the dispensing tube.

### DETAILED DESCRIPTION OF THE PREFERRED EMBODIMENTS

Referring to the accompanying drawings, like reference numbers indicate like elements. In the following detailed description of the preferred embodiments, references are made to the accompanying drawings which form a part hereof, and in which are shown by way of illustration specific embodiments in which the invention may be practiced. It is to be understood that other embodiments may be utilized and structural changes may be made without departing from the scope of the present invention.

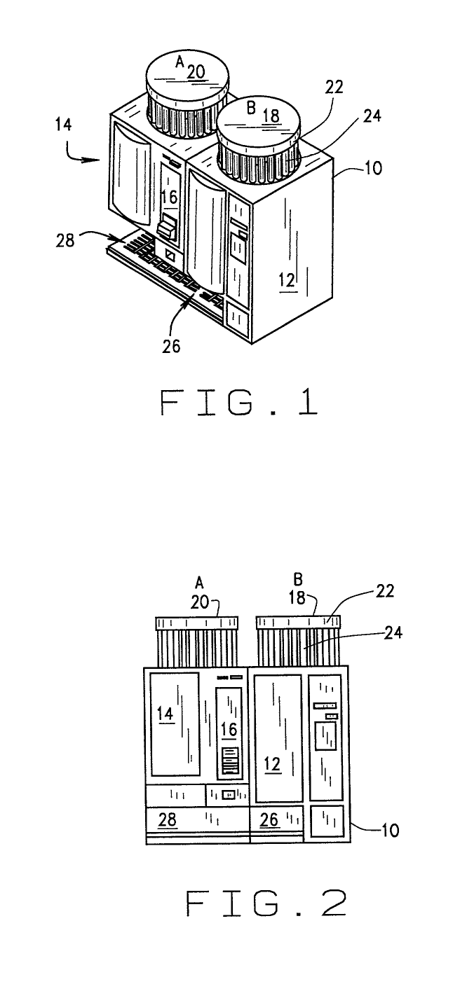

FIGS. 1 and 2 are perspective and front views of the exterior of the pasta and sauce vending apparatus of the present invention. Cabinet, 10, contains an apparatus for cooking and dispensing pasta on the right side, 12, and an apparatus for heating and dispensing sauce on the left side, 14. Operation is initiated in response to payment received by conventional vending machine payment means, 16. Payment means, 16, may include a bill validator, card reader for debit or credit cards, a coin mechanism, or any combination of the above. Each of these components, as well as their combination, are conventional in the vending machine industry. Those of skill in the art will recognize the equivalence of each of these components, and that these components have other equivalents for the purpose of receiving payment and thereafter initiating the vending process.

Pasta storage hoppers, 18 and 20, are disposed on top of the cabinet, 10. Pasta storage hopper, 18, is disposed in operative cooperation with pasta cooking and dispensing apparatus in the cabinet below it, 12, at position B. Pasta storage hopper, 20, is in the storage position A, on the left side of cabinet, 10. In the storage position, the hopper is not in operative communication with any pasta cooking means. In a preferred embodiment, a carriage (not shown) is available to facilitate transferring pasta storage hopper, 20, from a stored position, A, to an operative engagement position, B. Alternatively, and equivalently, a stockman/service man may simply lift pasta storage hopper, 20, from its storage position, A, and put it in operative engagement position, B, directly. A further equivalent of the present invention is contemplated to be the complete absence of a “spare” pasta storage hopper, 20, at a storage position, A. In this configuration, a stockman/service man would bring replacement pasta storage hoppers, A, with him for placement directly in operative engagement position, B.

Each pasta storage hopper incorporates a lid, 22, and individual portion cylinders, 24. Preferably there are twenty-five cylinders. Upon activation of the pasta cooking apparatus, an individual portion is dispensed from individual cylinder, 24, into the pasta cooking apparatus, described below. In the preferred embodiment, the individual serving of pasta descends by gravity through a through hole (not shown) in cabinet top, 10, below hopper, 18. The hopper is operatively engaged to a moving mechanism (not shown) which repositions, in the preferred embodiment by rotation, the hopper so that the next individual portion of pasta is disposed over the cabinet, 10, through hole (not shown) in a position ready for initiation of cooking that next portion of pasta. Thereby a next patron executing a next vend order will receive the next sequential individual serving of pasta from the next sequential individual serving storage cylinder.

After the pasta is cooked, it is dispensed onto a plate (not shown) placed in receiving station, 26.

Thereafter, the patron moves his or her plate of pasta to sauce receiving station, 28. The patron pushes a button (not shown) to activate the dispensing of sauce on top of the pasta.

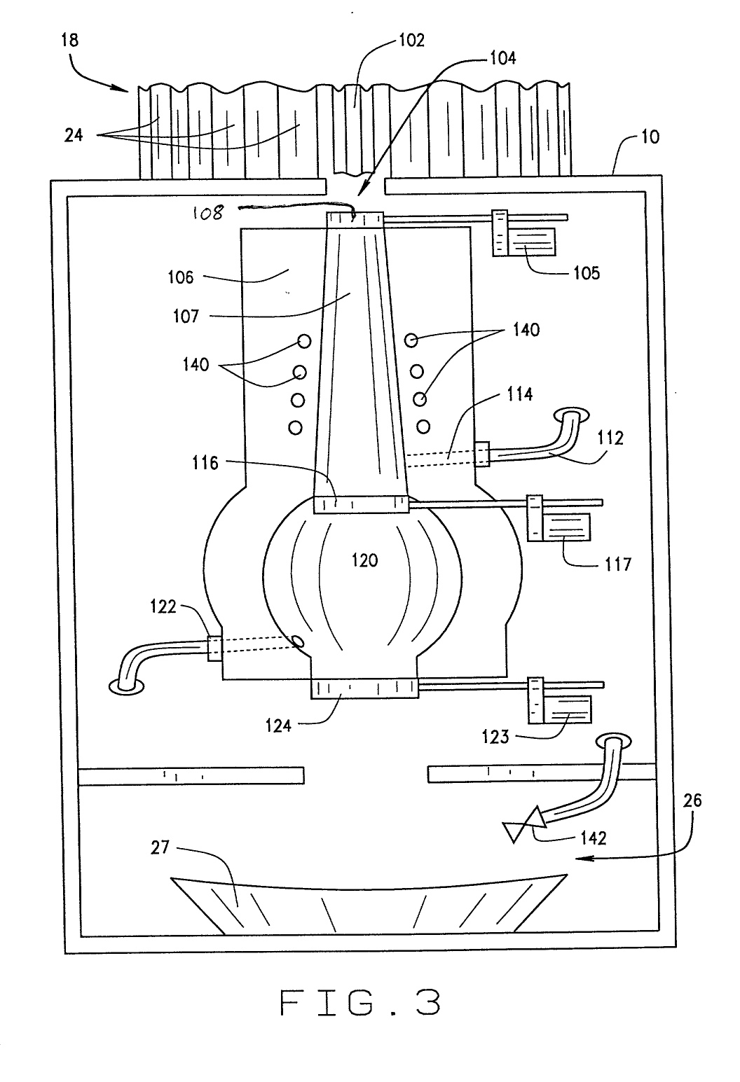

FIG. 3 depicts the pasta cooking and dispensing apparatus contained within the right (equivalently, left) side, 12, of cabinet, 10. Individual portions of pasta, 102, are held within the individual serving cylinders, 24. Pasta storage hopper, 18, preferably a drum, is moved, preferably rotated, so that an individual portion of pasta, 102 is disposed above a through hole/pasta conduit, 104. Upon receipt of a patron's payment, a relay (not shown) activates a mechanism, 105, for example, to open a trap door or gate, 108, to allow an individual portion of pasta, 102, to proceed through conduit, 104, into pasta cooking container, 106 having a chamber, 107. In a preferred embodiment, the progress of pasta through cooking and dispensing stages is by gravity. It is contemplated that equivalent means of propelling pasta through the cooking and dispensing apparatus is within the scope of this invention, including but not limited to mechanical means or pressure means.

The sequential execution of process steps by the apparatus of the present invention is preferably by means of conventional electrical relays. It is contemplated to be within the scope of this invention that other system control means may be used, such as programmable logic circuits or software controlled processing. Appropriate systems controls are well known to those of skill in the art.

Upon receipt of the pasta, 102, within the pasta cooking chamber, 107, gate, 108, closes behind the pasta. Water is received into pasta cooking chamber, 107, through conduit, 112, by means of opening valve, 114. Water is received from any source, preferably through a standard plumbing connection to a building water supply. Equivalently, water may be stored or pre-heated in an auxiliary tank (not shown) and/or an annular chamber (not shown) incorporated into the cooker housing, 106.

The sealed cooking chamber is then heated by elements, 140. Some moderate amount of pressure is created, but the water is not under any pressure before entering the cooking chamber. A pre-programmed timer (not shown) determines when the pasta has reached the desired cooked texture through being pre-programmed with data correlating time, temperature and desired texture. Preferably, the timer may be adjusted by a serviceman at the machine, or by a connection to remote control, as through the Internet. It is anticipated, but not required, that the apparatus of the present invention will cook pastas in about 2 minutes, total. In the preferred embodiment, the pasta is cooked in the first cooking chamber for about one minute.

Upon completion of its period, the timer actuates a motor, 117, to open the lower pasta cooking chamber valve or gate, 116, to allow egress of the pasta, 102, and hot water from the first pasta cooking chamber to a second cooking chamber, 120. In the second chamber, 120, the pasta finishes cooking at atmospheric pressure. Cooking is competed by the still hot water from first cooking chamber, 107.

A second timer, or, equivalently, the same timer or a programmable logic circuit, actuate a valve, 122, to drain the hot cooking water. Nozzle, 142, sprays fresh water onto a plate, 27, to prevent the pasta from sticking. Then motor, 123, opens a lower second cooking chamber gate, 124, upon completion of the entire cooking cycle. Gate, 124, thereby acts as a cooked pasta dispenser. Thereafter, the now cooked pasta descends, preferably by gravity, through second cooking chamber exit gate, 124, and onto a plate, 27, which the patron has placed in pasta receiving station, 26.

A pasta cooking apparatus consistent with a preferred embodiment includes features not depicted in FIG. 3, including an unpressurized water staging tank, an unpressurized hot water pre-heating chamber in an annular configuration around first pasta cooking chamber, 107, and insulation. Automated control systems consistent with a preferred embodiment are well known in the art and do not need to be disclosed in further detail here.

In a preferred embodiment the pasta cooker receives, cooks and dispenses a portion of pasta in approximately two minutes or slightly longer. No cooking chamber uses augmented, increased pressure, although sealing the first cooking chamber will result in consequential pressure increases not exceeding three bar.

It is further contemplated to be within the scope of the present invention that other pasta cooking devices may be incorporated into the pasta and sauce vending apparatus of the present invention. Hence, alternative embodiments may incorporate any of number of pasta cookers including cookers designed to produce hot pasta in less than two minutes, pasta cookers designed to cook at higher pressures, pasta cookers designed to cook at a pressure greater than three bar in at least one chamber and including, without limitation, such pasta cookers as are disclosed in U.S. Pat. Nos. 5,033,364; 5,010,806; 5,172,627; and 5,215,011, to Narcisi, which are incorporated herein by reference.

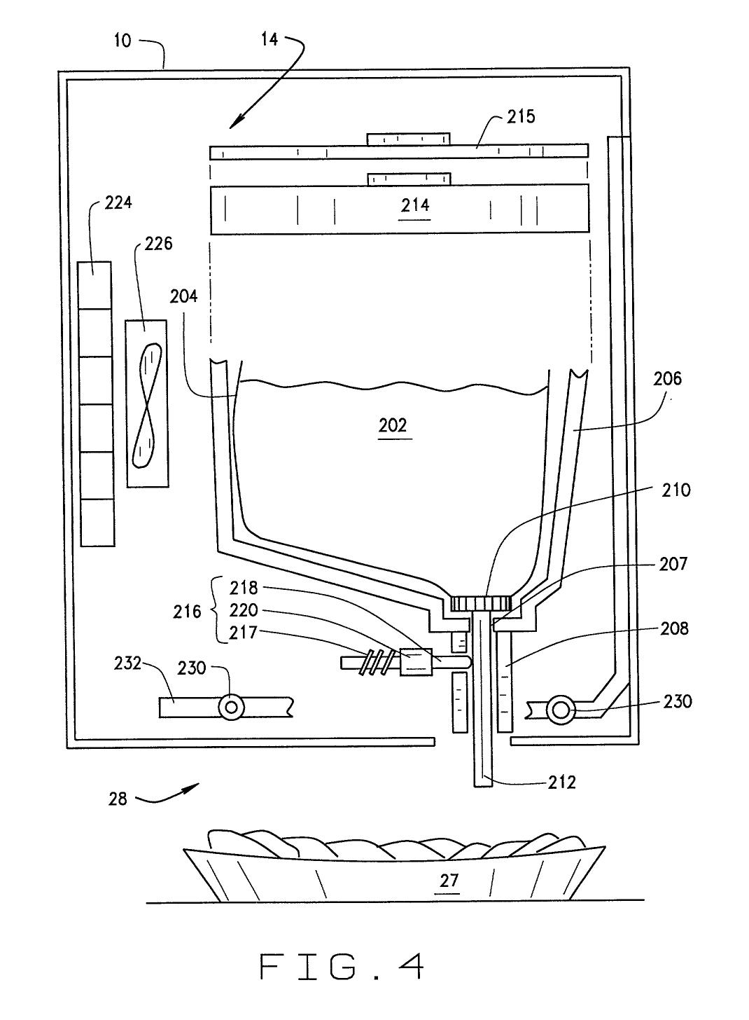

FIG. 4 is a side view of the internal apparatus for dispensing the pasta sauce contained in sauce dispensing housing, 14, which is in turn within cabinet 10. Sauce, 202, is contained within disposable sauce container, 204. The dispenser bag may be any size, but in the preferred embodiment is about 200 ounces, as is consistent with sauce for 25 servings of pasta. Alternatively differing volumes may be used, as may be consistent with optimal restocking cycles and routing logistics for particular users, suppliers or machine locations.

Sauce container, 204, is removably disposed within holder, 206. The holder, 206, can be a bucket, basket or any other weight supporting convexity for receiving and sustaining the weight of the sauce within the sauce container, 204. Sauce container holder, 206, incorporates a through hole, 207, in operative communication with an axial through hole in guide sheath, 208, which is fixedly attached to holder, 206. Holder through hole, 207, and guide sheath, 208, are preferably located at or near the bottom of holder, 206, to facilitate dispensing by gravity flow. Sauce container, 204, is attached to adaptor, 210, which is a threaded cap or ring through which sauce may pass. The adaptor holds sauce container, 204, in operative communication with dispensing tube, 212. Thereby, sauce, 202, is in dispensable communication through adaptor, 210, and thence through dispensing tube, 212, for dispensing directly onto a plate of pasta, 27. The dispensing tube, 212, hangs lower than the guide sheath, 208, so the sauce never contacts the sheath or other permanent equipment. Therefore no cleaning is necessary.

Flow of sauce, 202, through dispensing tube, 212, is preferably impelled by gravity. In an alternative embodiment, gravity impulsion may be assisted by a pressure weight, 214, which weight may be easily removeable by a serviceman for periodic replacement of sauce container, 204. Optionally, a lid, 215, may cover holder, 206, with or without weight, 214. It is contemplated that any means of impelling sauce through the dispenser tube is within the scope of this invention, including but not limited to mechanical means, spring means, electromechanical means, pneumatic or hydraulic means.

Control of the flow of sauce, 202, through dispensing tube, 212, is by valve, 216. Dispensing tube, 212, may be made of silicon rubber, natural rubber, latex, or any other flexible material compatible with food dispensing. Any dispensing tube material, flexible or rigid, is equivalent, provided it is compatible with flow control means equivalent to valve 216, compatible with food storage, and extendible below the terminus of guide sheath, 208. Dispensing tube guide sheath, 208, has a hole along one wall. Valve, 216, is comprised of a ram, 218, disposed within said guide sheath hole and traveling therethrough in order to constrict dispensing tube, 212, such that it may be pinched shut, thereby halting the flow of sauce through it. Preferably, the outside diameter of a rounded valve ram tip matches the inside diameter of the inside channel of the guide sheath. The valve is held closed by spring, 217, which biases ram, 218, closed. Opening and closing of valve, 216, is actuated by solenoid, 220. Solenoid, 220, is activated in response to closing of a relay by a customer pushing a push button (not shown). This button may activate continuous flow of sauce or dispense a predetermined volume by timer. It is contemplated to be within the scope of the present invention that any valve means capable of halting the flow of sauce through the dispensing tube, 212, may be used, in a manner equivalent to the operation of the solenoid valve described herein.

Dispensing sauces of various types, viscosity and particulate content are all contemplated to be within the scope of this invention. Additionally, the herein above described sauce dispensing apparatus may be incorporated two or more times within vending cabinet, 10, to give a patron a choice of sauces. It is further contemplated that varying degrees of pressure may be necessary to dispense sauces of varying viscosity and particulate content. Hence, it is within the scope of the current invention to dispense by gravity alone, or by gravity assisted by a pressure system, such as a weight, 214, or other impulsion equivalents. The sauce container of the present invention is preferably plastic, but any material compatible with food storage, open to outside air or sealed, or re-sealable is equivalent. The container is preferably flexible, but partially flexible or rigid containers are equivalent. The holder, 204, is preferably a metal bucket, but mesh plastic, baskets or any suitable convexity rigid enough to support the weight of the sauce is equivalent.

It is contemplated to be within the scope of the present invention that various bores of dispensing tubes and guide sheathes may be used to accommodate sauces of varying viscosity and particulate content.

Preferably sauce is dispensed while warm. Warming the sauce is achieved by incorporating within the sauce dispensing housing, 14, a heater, 224, and a fan, 226, for dispersement of the heat around the sauce container, 204, by convection. It is contemplated to be within the scope of this invention that other equivalent means of heating the sauce may be used.

A serviceman/stockman may access the sauce container holder, 206, in order to remove an empty or stale sauce container, 204, by any of a variety of equivalent access panels, lids or the like. In a preferred embodiment access is had by a drawer. A conventional drawer roller means, such as wheels, 230, and carriage, 232, (cut away in FIG. 4) allow a stockman easy, efficient and rapid access to pasta sauce storage container, 204, for servicing and replacement.

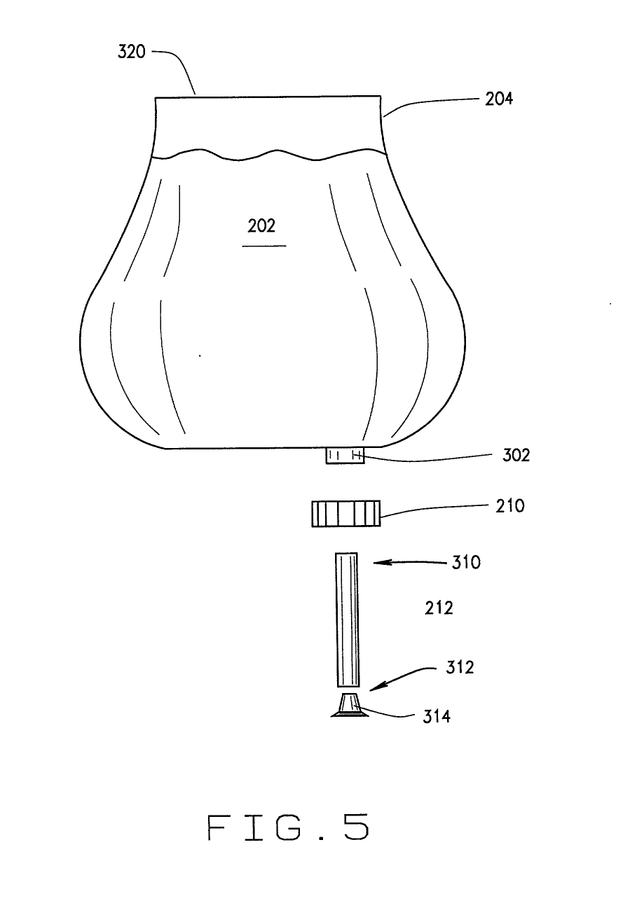

FIG. 5 depicts an embodiment of the sauce container, 204, before being assembled and placed within the sauce dispensing apparatus. Sauce, 202, is contained within flexible, preferably plastic, most preferably vinyl, container, 204. Container, 204, incorporates a nipple, or sealed spout, 302, forming a male portion adapted to fit within adaptor, 210. Adaptor, 210, may be attached to container, 204, by any conventional methods. Preferably, a stock man will invert container, 204, cut the male nipple or unseal the spout, 302, thereby creating a through hole in the wall of container, 204. Then adaptor, 210, is attached in order to operatively receive communication with the interior of container, 204. Adaptor, 210, is fixedly attached to flexible dispensing tube, 212.

Flexible dispensing tube, 212, is received from packaging with a sealed end, 310, and an open end, 312. The open end is fixed to the adapter, 210. Sealing may be by any conventional method including but not limited to equivalents such as a plugged end, pinched end, molded end or a crimped end. Preferably, a plug, 314, is used. In any case, upon attachment of adaptor, 210, and dispensing tube, 212, to container, 204, sauce may be communicated from container, 204, and into tube, 212, but may not thereafter exit the tube, 212, due to the sealed end.

The serviceman accesses the old sauce container, by drawer, lid or the equivalent. Opening the drawer automatically turns off the sauce heater. The serviceman plugs the open end of the dispensing tube of the previous sauce bag to prevent spillage. A switch (not shown) accessible only to the serviceman opens valve, 216, and holds it open. The old sauce container is removed.

After assembly of the new sauce container, 204, with adaptor, 210, and dispensing tube, 212, the assembly is inverted and the dispensing tube, 212, is inserted in the guide sheath, 208, and the container, 204, placed within holder, 206. After the valve, 216, is closed again on dispensing tube, 212, so that the sauce cannot flow through it, the service man simply unseals the end of the new dispensing tube, 212. Dispensing tube, 212, is longer than guide sheath, 208, and therefore extends below the terminal opening of guide sheath, 208. In this manner, the sauce never touches guide sheath, 208, or any other part of any dispensing apparatus, other than the container, 204, and sheath, 212.

After a fresh container of sauce has been placed in the sauce dispensing apparatus, the old sauce bag, adaptor and dispensing tube are discarded. In this manner, no time is taken during the stockman/serviceman's route for cleaning of machinery. The stockman/service man simply removes a pasta containing drum and replaces it with a full drum, removes the sauce container bag and replaces it with a new sauce container/dispensing tube assembly, unseals the end of the dispenser tube and may continue on this route. Spillage of sauce during removal of the old sauce bag is prevented by simply re-plugging the dispenser tube for removal.

Sauce containers are anticipated to have a sealed shelf life measured in months. After opening it is contemplated within the scope of the present invention that a preferred sauce container and dispensing tube would have a shelf life of approximately five days, although variable shelf lives are equivalent.

In an alternative embodiment, the sauce container, 204, may include an openable seal. 320, along its top aspect. In this embodiment, the container, 204, adapter, 210, and dispensing tube, 212, remain in place through a plurality of restocking cycles. Restocking is then achieved by the stockman/serviceman directly pouring sauce from a mobile container into the apparatus sauce container, 204, after opening the sealable top. Upon refilling container, 204, the stockman would reseal the top.

In view of the foregoing, it will be seen that the several advantages of the invention are achieved and attained.

The embodiments were chosen and described in order to best explain the principles of the invention and its practicable application to thereby enable others skilled in the art to best utilize the invention and various embodiments and with various modifications as are suited to the particular use contemplated.

It is contemplated that the present invention may cook, dispense and vend similar food products and still be within the scope of and equivalent to the present invention, as, by way of example and not by limitation, chinese noodles and sauce, rice and sauce or the like.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above described exemplary embodiments, but should be defined only in accordance with the following claims appended hereto and their equivalents.

We claim:

1. A pasta and sauce vendor comprising:
a hopper storing at least one portion of pasta;
a pasta cooker for cooking a portion of pasta received from said hopper;
a pasta dispenser for dispensing the portion of cooked pasta received from said pasta cooker;
a disposable sauce container having a dispensing tube;
a holder for said disposable sauce container that disposes the dispensing tube of said container to dispense sauce directly onto the cooked pasta such that the sauce contacts only the container dispensing tube and the cooked pasta; and
a vending circuit whereby a payment is received, and, in response to the receipt of the payment, the pasta is cooked and dispensed and thereafter the sauce is dispensed.

2. The pasta and sauce vendor of claim 1 wherein said disposable sauce container has a re-sealable opening for re-filling said container with sauce.

3. The pasta and sauce vendor of claim 1 wherein said holder comprises:
a sauce container support having a through hole;
a dispenser tube guide sheath in communication with the through hole of said support;
a sauce flow control valve that blocks or releases a flow of sauce through the dispenser tube disposed in said dispenser tube guide sheath.

4. The pasta and sauce vendor of claim 1 further comprising a pressure applicator for impelling sauce through said dispensing tube.

5. The pasta and sauce vendor of claim 1 further comprising a sauce heater.

6. The pasta and sauce vendor of claim 4 wherein said pressure applicator is a weight.

7. The pasta and sauce vendor of claim 1 wherein said cooker cooks pasta at a pressure less than three bar and in a time of at least two minutes.

8. The pasta and sauce vendor of claim 1 wherein said cooker exceeds a pressure of three bar at least once during the cooking of the pasta, and in a time less than two minutes.

9. The pasta and sauce vendor of claim 1 wherein said vendor cooks and dispenses food materials other than pasta and sauce.

10. A pasta and sauce vendor comprising:
a housing having a through hole for receiving uncooked portions of pasta, a cooked pasta receiving station, and a pasta sauce container access drawer;
a hopper removeably affixed to said housing storing a plurality of portions of pasta and moveable to dispose individual portions of pasta into communication with the through hole of said housing;
a pasta cooker fixedly attached within said housing and in communication with the through hole of said housing for receiving an individual portion of uncooked pasta from said hopper, said cooker having a top gate that opens to receive the portion of pasta and closes to cook the portion of pasta and having a bottom gate for dispensing the portion of pasta when cooked into the cooked pasta receiving station of said housing;
a disposable sauce container having a flexible dispensing tube with a plug;
a holder for said sauce container fixedly attached within the sauce container access drawer of said housing, said holder having a through hole;
a dispenser tube guide sheath in communication with the through hole of said holder;
a sauce flow control valve fixedly attached to said guide sheath, said valve closing upon the dispenser tube disposed within said guide sheath to block sauce flow and opening to allow sauce flow; and
a vending circuit whereby a payment is received, and, in response to the receipt of the payment, the pasta is cooked and dispensed and thereafter the sauce is dispensed;
whereby said pasta hopper may be replaced when empty and the sauce container access drawer of said housing opens to allow plugging of the dispensing tube, opening of said flow control valve, removal of said disposable sauce container, replacement of said disposable sauce container with a fresh container, closing of said control valve, removal of the dispensing tube plug and closing of the access drawer of said housing to allow a next cycle of vending.

11. The pasta and sauce vendor of claim 10 wherein said disposable sauce container has a re-sealable opening for re-filling said container with sauce.

12. The pasta and sauce vendor of claim 10 further comprising a sauce heater.

13. The pasta and sauce vendor of claim 10 further comprising a pressure applicator for impelling sauce through said dispensing tube.

14. The pasta and sauce vendor of claim 13 wherein said pressure applicator is a weight.

15. The pasta and sauce vendor of claim 10 wherein said cooker cooks pasta at a pressure less than three bar and in a time of at least two minutes.

16. The pasta and sauce vendor of claim 10 wherein said cooker exceeds a pressure of three bar at least once during the cooking of the pasta, and in a time less than two minutes.

17. The pasta and sauce vendor of claim 10 wherein said vendor cooks and dispenses food materials other than pasta and sauce.

18. A disposable pasta sauce container comprising:
an at least partially flexible bag having a through hole;
a dispensing tube having an open end in fluid communication with the through hole of said bag and having a terminal end with a removable seal that blocks sauce flow until removed.

19. The disposable pasta sauce container of claim 18 wherein said dispensing tube is flexible.

20. The disposable pasta sauce container of claim 18 wherein said dispensing tube is made of a material selected from the group consisting of: silicone, latex, rubber and plastic.

21. The disposable pasta sauce container of claim 18 wherein said sauce container is openable and re-sealable.

22. The disposable pasta sauce container of claim 18 wherein said container contains food materials other than pasta sauce.

23. A method of maintaining a pasta and sauce vendor comprising:
stocking a hopper with portions of pasta;
loading the hopper into operative disposition with said pasta and sauce vendor such that the portions of pasta may be received by a pasta cooker within said pasta and sauce vendor for cooking; and
loading a pasta sauce container into operative disposition within said pasta and sauce vendor such that sauce contacts only the pasta sauce container and a dispensing tube when dispensed.

24. The method of maintaining a pasta and sauce vendor of claim 23 wherein said pasta sauce container loading step comprises opening a seal in the pasta sauce container, stocking pasta sauce within the container and re-sealing the container.

25. The method of maintaining a pasta and sauce vendor of claim 23 wherein said vendor cooks and dispenses food materials other than pasta and sauce.

26. The method of maintaining a pasta and sauce vendor of claim 23 further comprising the steps of:
joining the pasta sauce container to a pasta sauce dispensing tube having a plug;
plugging the dispensing tube of the pasta sauce container to be replaced;
opening a pasta sauce flow control valve so that the valve releases contact with the pasta sauce dispensing tube attached to the pasta sauce container to be replaced;
removing the pasta sauce container to be replaced, along with the plugged pasta sauce dispensing tube attached to the pasta sauce container to be replaced, from said pasta and sauce vendor;
installing the pasta sauce container within said pasta and sauce vendor;
disposing said plugged dispensing tube attached to said pasta sauce container within a dispensing tube guide sheath;
closing the pasta sauce flow control valve; and
unplugging the dispensing tube.

27. The method of maintaining a pasta and sauce vendor of claim 26 wherein said pasta sauce container loading step comprises opening a seal in the pasta sauce container, stocking pasta sauce within the container and re-sealing the container.

28. The method of maintaining a pasta and sauce vendor of claim 26 wherein said vendor cooks and dispenses food materials other than pasta and sauce.

29. A method of vending pasta and sauce comprising:
stocking a hopper with portions of pasta;
loading the hopper into operative disposition with a pasta and sauce vendor such that the portions of pasta may be received by a pasta cooker within the pasta and sauce vendor for cooking;
loading a pasta sauce container into operative disposition with the pasta and sauce vendor such that sauce contacts only the sauce container and a dispensing tube when dispensed;
receiving payment from a consumer, and in automated response to said payment receipt;
intaking a portion of pasta from the hopper into a pasta cooker;
cooking the pasta;
dispensing the pasta; and
dispensing sauce in response to the consumer initiating sauce dispensing with a sauce dispensing actuator.

30. The method of maintaining a pasta and sauce vendor of claim 29 wherein said vendor cooks and dispenses food materials other than pasta and sauce.

31. The method of maintaining a pasta and sauce vendor of claim 29 wherein said pasta sauce container loading step comprises opening a seal in the pasta sauce container, stocking pasta sauce within the container and re-sealing the container.
